(19) United States
(12) Patent Application Publication
(10) Pub. No.: US 2007/0103900 A1
(43) Pub. Date: May 10, 2007

(54) White light emitting device

(76) Inventors: Kun Chui Lee, Taipei City (TW); Tzu-Chi Cheng, Baoshan Township (TW); Jung-Pin Cheng, Taipei City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/269,657

(22) Filed: Nov. 9, 2005

(51) Int. Cl. F21V 9/00

(52) U.S. Cl. 362/231

(57) ABSTRACT

A white light emitting device is composed of at least more than one blue light LED which can emit a blue light, at least more than one red light LED which can emit a red light, and an illuminator made by uniformly mixing a greenish yellow illumination material, a blue illumination material, and a transparent glue, wherein the illuminator can absorb the blue light, such that the illuminator will be excited to a first mixed light having a wavelength different than that of the blue light. The first mixed light is mixed with a red light emitted from the red light LED to release a second mixed light which is provided with a high rendering effect and saturation of color.

### BACKGROUND OF THE INVENTION

a) Field of the Invention

The present invention relates to a white light emitting and more particularly to a device by which a second mixed light with a high rendering effect can be released.

b) Description of the Prior Art

A typical example of a conventional light emitting device includes a Taiwan Patent publication No. 383508, “Light Emitting and Display Devices,” applied by the Japanese Nichia Corporation, wherein only a blue light semiconductor of a single blue light source is used to emit a blue light for exciting a yellow illumination layer, so as to display a white light of different wavelength. As the invention only mixes a light of single wavelength with the blue light whose portion is not excited, the rendering effect is inferior, i.e., the white light is distorted and not pure.

### SUMMARY OF THE INVENTION

The primary object of present invention is to provide a white light emitting device, and in particular, a device which excites an illuminator, which is made by mixing a greenish yellow illumination material with a blue illumination material, by a blue light emitted from a blue light LED, to generate a first mixed light comprising the greenish yellow light and the blue light. The first mixed light is mixed with a red light LED to form a second mixed light having a high rendering effect and saturation of color.

Another object of the present invention is to provide a white light emitting device, wherein an illuminator, which is formed by mixing a greenish yellow illumination material, a blue illumination material, and a red illumination material, is excited by a blue light emitted from a blue light LED to generate a first mixed light comprising the greenish yellow light, the blue light, and the red light. The first mixed light is mixed with a red light emitted from a red light LED to form a second mixed light having a high rendering effect and saturation of color.

Still another object of the present invention is to provide a white light emitting device, wherein a second mixed light having a high rendering effect and saturation of color can be formed by mixing a greenish yellow light, which is emitted from a greenish yellow LED added to light emitting elements, with a first mixed light.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cross sectional view of a device of the present invention.

FIG. 2 shows a flow diagram of a color rendering of the present invention.

FIG. 3 shows a curve of independent wavelengths of an active light emitting LED and a passive light emitting illuminator of the present invention.

FIG. 4 shows a curve of wavelength of a second mixed light of the present invention.

FIG. 5 shows a flow diagram of a color rendering after adding a red illumination material to an illuminator of the present invention.

FIG. 6 shows a curve comparing a wavelength of a second mixed light with a waveform of daylight of the present invention.

FIG. 7 shows a curve of wavelength of a second mixed light after mixing a passive red light source and a greenish yellow light source of the present invention.

FIG. 8 shows a flow diagram of another implementation of the present invention.

FIG. 9 shows a cross sectional view of another implementation of the present invention.

### DETAILED DESCRIPTION OF THE PREFERRED EMBODIMENTS

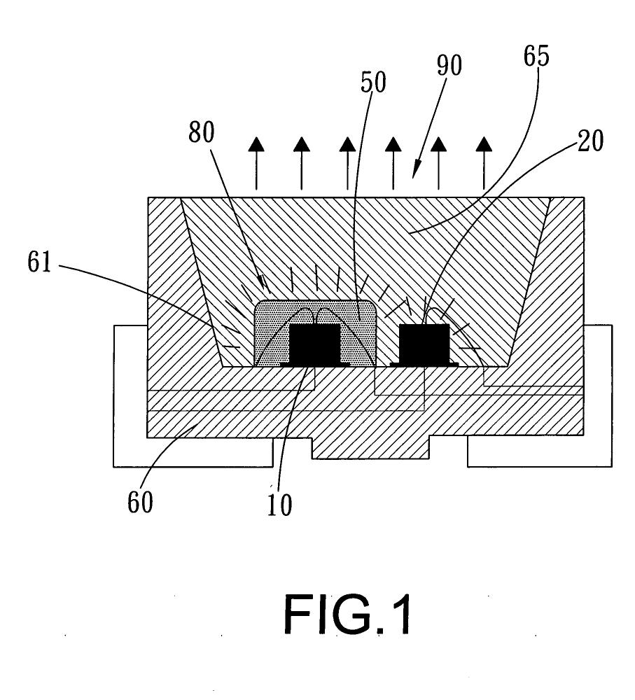

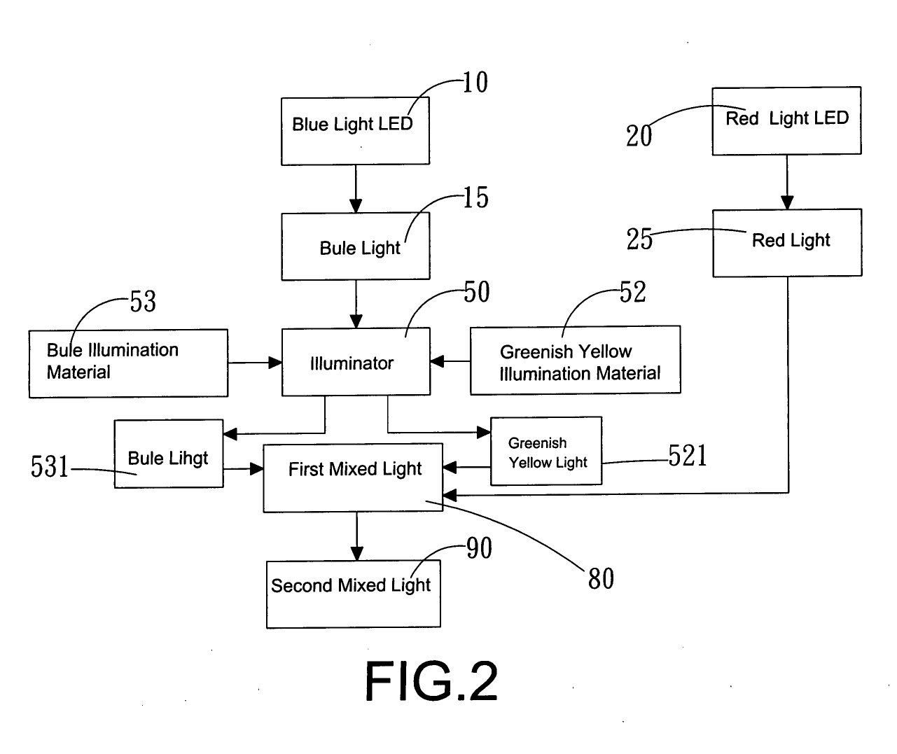

The present invention is to provide a white light emitting device, as shown in FIG. 1 and FIG. 2, which includes at least more than one blue light LED 10 which can emit a blue light 15, more than one red light LED 20 which can emit a red light, and an illuminator 50 made by uniformly mixing a greenish yellow illumination material 52, a blue illumination material 53, and a transparent glue (not shown in the drawings), wherein the greenish yellow illumination material 52 is made by an Aluminate material using cerium (Ce) as its activator, and the blue illumination material 53 is made by an Aluminate material using europium (Eu) as its activator.

The illuminator 50 is covered on an upper surface of the blue light LED 10, in order to absorb the blue light 15, such that the illuminator 50 can be excited to a first mixed light 80 having a wavelength different than that of the blue light 15. A second mixed light 90 is released by mixing the first mixed light 80 with the red light 25 emitted from the red light LED 20.

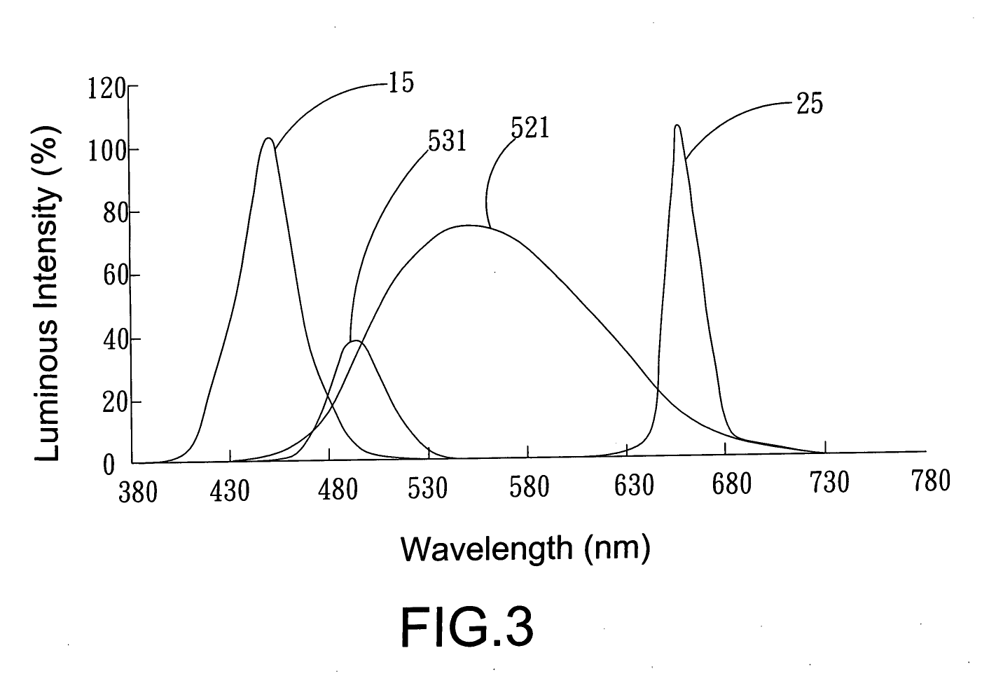

The greenish yellow illumination material 52 in the illuminator 50 is excited to a greenish yellow light 521 with a wavelength specified to be between 500 nm and 585 nm, by the blue light 15 (as shown in FIG. 3). A blue light 531 emitted from the blue illumination material 53 which is excited by the blue light 15 has a specified wavelength between 450 nm and 500 nm. The first mixed light 80 is formed by mixing these two lights of different colors.

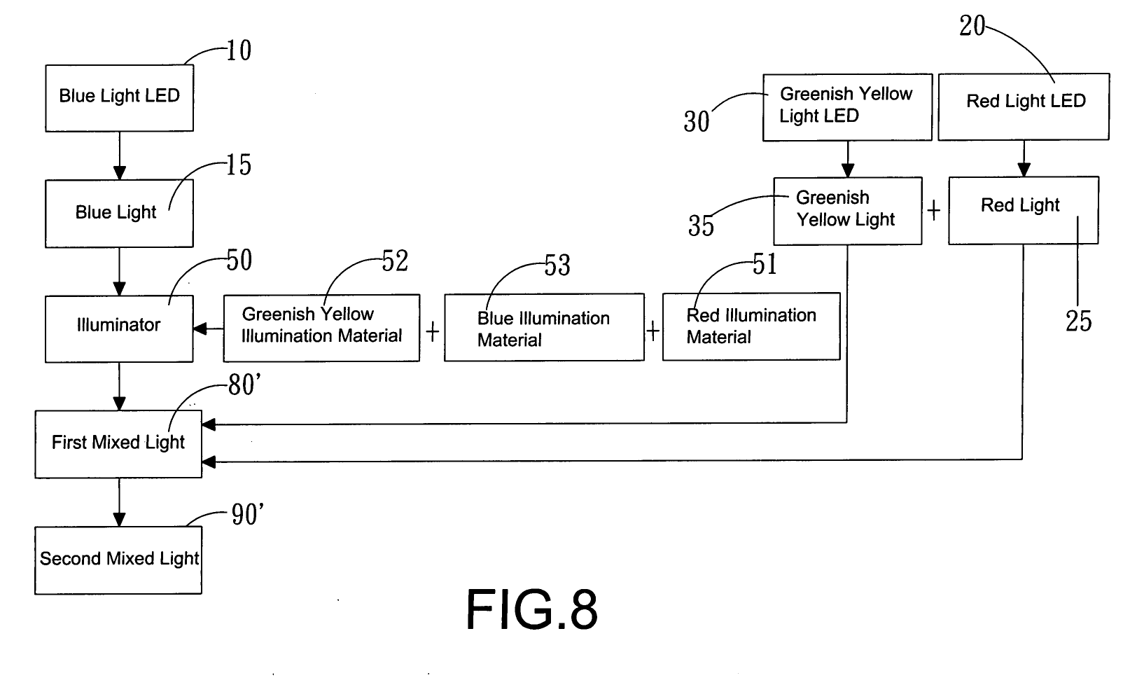

Accordingly, as shown in FIG. 8, a red illumination material 51 can be added to the illuminator 50 to be mixed with the original greenish yellow illumination material 52 and the blue illumination material 53. A red light 511 emitted from the red illumination material 51 which is excited by the blue light 15 has a specified wavelength between 585 nm and 700 nm.

Accordingly, as shown in FIG. 1, the blue light LED 10 and the red light LED 20 are installed in a reflection slot 61 of a light reflection cap 60, the illumination layer 50 made by mixing the greenish yellow illumination material 52 and the blue illumination material 53 is covered on the blue light LED 10, and a transparent glue 65 is filled in the slot 61 to cover the illumination layer 50 and the red light LED 20.

Referring to FIG. 1 and FIG. 2, the present invention is to provide a white light emitting device which includes at least more than one blue light LED 10 which can emit a blue light 15, more than one red light LED 20 which can emit a red light 25, more than one greenish yellow light LED 30 which can emit a greenish yellow light 35 (as shown in FIG. 8), and an illuminator 50 which is made by uniformly mixing a greenish yellow illumination material 52, a blue illumination material 53, and a transparent glue (not shown in the drawings). The greenish yellow illumination material 52 is made by an Aluminate material using cerium (Ce) as its activator, and the blue illumination material 53 is made by an Alluminate material using europium (Eu) as its acticator. The illuminator 50 is covered on an upper surface of the blue light LED 10 to absorb the blue light 15, such that the illuminator 50 can be excited to a first mixed light 80 having a wavelength different than that of the blue light 15. A second mixed light 90 is then released by mixing the first mixed light 80, the red light 25, and the greenish yellow light 35. The greenish yellow light 521 emitted from the greenish illumination material 52 in the illuminator 50 which is excited by the blue light 15 has a specified wavelength between 500 nm and 585 nm (as shown in FIG. 3). The blue light 531 emitted by the blue illumination material 53 which is excited by the blue light 15 has a specified wavelength between 450 nm and 500 nm. The first mixed light 80 is formed by mixing these two lights of different colors.

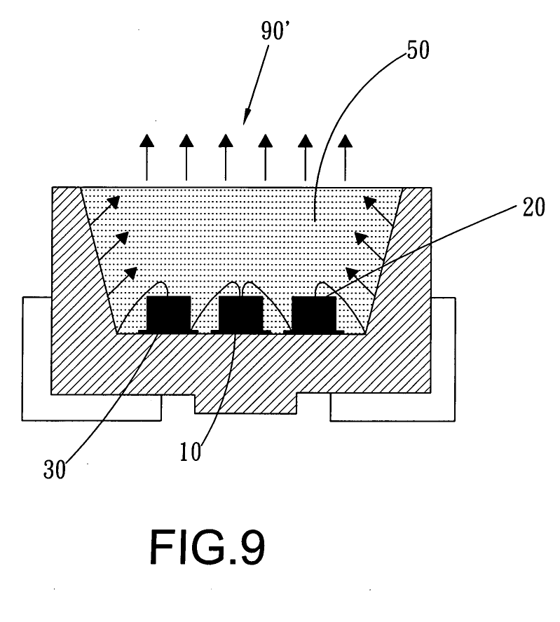

Accordingly, as shown in FIG. 9, the blue light LED 10, the red light LED 20, and the greenish yellow light LED 30 are installed in a slot 61 of a light reflection cap 60, and the illumination layer 50 made by mixing the greenish yellow illumination material 52 with the blue illumination material 53 is filled in the slot 61.

Accordingly, the blue light 15 emitted from the blue light LED 10 has a wavelength between 400 nm and 480 nm, the red light 511 emitted from the red light LED 25 has a wavelength between 585 nm and 780 nm, and the greenish yellow light 35 emitted from the greenish yellow light LED 30 has a wavelength between 500 nm and 585 nm.

Accordingly, the greenish yellow illumination material 52, the blue illumination material 53, and the red illumination material 51 in the illuminator 50 can be chosen from one of or a combination of the following materials: (1) the Aluminate series, (2) the Silicate series, (3) the Phosphate series, (4) the Bornate series, and (5) the Sulfide series.

Referring to FIG. 1, a blue light LED 10 and a red light LED 20 are installed in a light reflection cap 60 whose lower side is connected to wire frames 62, 63 of positive and negative electrodes. An illuminator 50 can be covered on an upper surface of the blue light LED 10, and a transparent glue 65 is sealed in a slot 61 of the light reflection cap 60, thereby packaging the blue light LED 10 and the red light LED 20. As shown in FIG. 2, by putting the electrodes to the blue light LED 10 and the red light LED 20, the blue light LED 10 will emit a blue light 15 with a wavelength between 400 nm and 480 nm. The illuminator 50 is made by mixing a greenish yellow illumination material 52 and a blue illumination material 53, wherein the greenish yellow illumination material 52 absorbs a portion of blue light 15 to excite to a greenish yellow light with a wavelength between 500 nm and 585 nm, and the blue illumination material 53 absorbs a portion of blue light 15 to excite to a blue light 531 with a wavelength between 450 nm and 500 nm. The excited greenish yellow light 521 and the blue light 531 are mixed to form a first mixed light to be released. The red light LED 20 emits a red light 25 with a wavelength between 585 nm and 780 nm, which will be mixed with the first mixed light 80 to form a second mixed light 90.

Referring to FIG. 3, it shows a curve of wave forms of the independent blue light 15, the red light 25, the excited greenish yellow light 521, and the excited blue light 531 before mixing. It is concluded that all of the blue light 15, the red light 25, the passive greenish yellow light 521 and blue light 531 have a specific wavelength and luminous intensity.

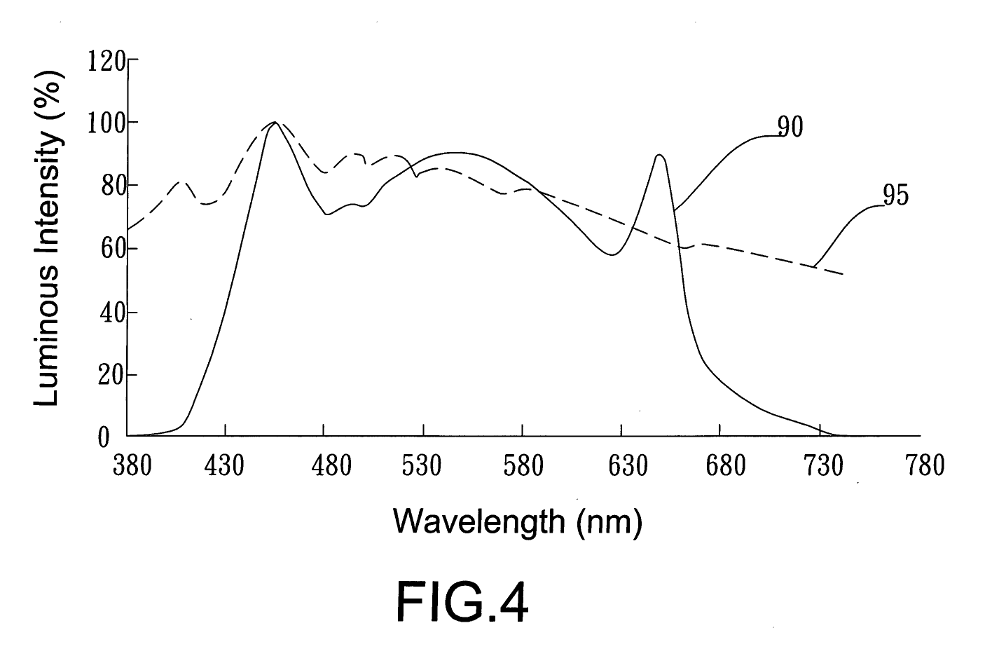

Referring to FIG. 4, it shows a curve of the blue light 15, the red light 25, the greenish yellow light 521, and the blue light 531 after mixing. The second mixed light 90 is formed by mixing, with an average wavelength between 400 nm and 700 nm. By comparing the second mixed light 90 with a hypothetical daylight spectrum 95 (or the natural light), it is concluded that the second mixed light 90 and the daylight spectrum 95 have an extremely high rendering effect in the visible light region of the wavelength between 400 nm and 680 nm. Therefore, the second mixed light 90 achieved by the present invention has a color rendering effect (such as a white light) which is closer to the natural light, and is provided with an enhanced saturation of color.

The illuminator 50 is primarily made by uniformly mixing the greenish yellow illumination material 52 with the blue illumination material 53, which will generate a different reaction in light enabling color according to a variation of proportion of their elements. The light enabling color of the greenish yellow illumination material 52 is greenish yellow, and the light enabling color of the blue illumination material 53 is blue. Therefore, a same material can be chosen for the greenish yellow illumination material 52 and the blue illumination material 53, but different light enabling colors will be generated if the proportions are different. The material of illuminator 50 of present invention can be chosen from one of or a combination of a plurality of the following elements: (1) the Aluminate series, (2) the Silicate series, (3) the Phosphate series, (4) the Bornate series, and (5) the Sulfide series.

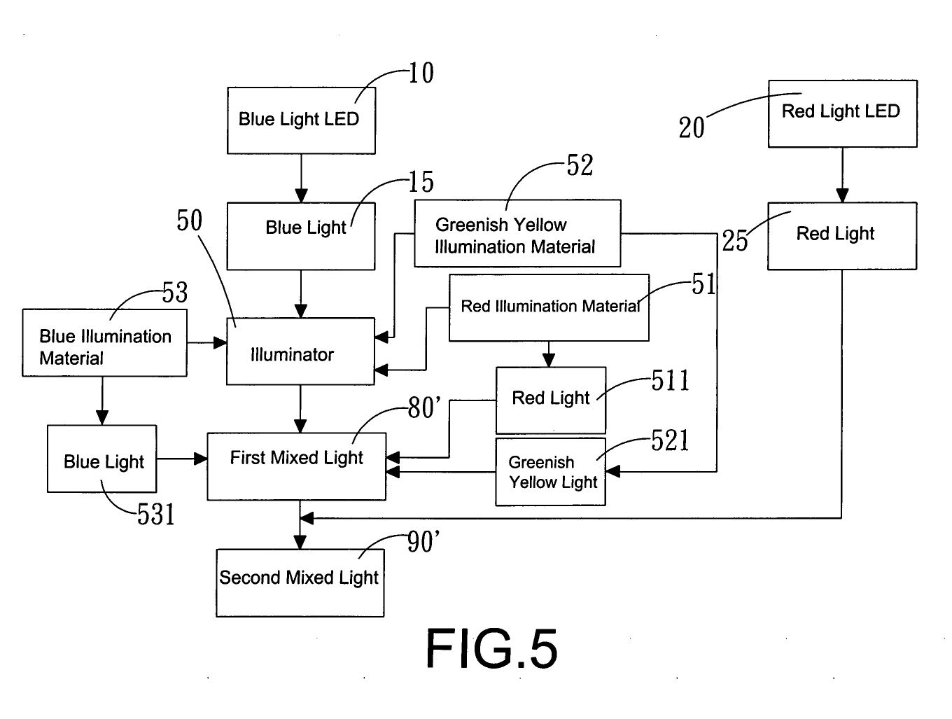

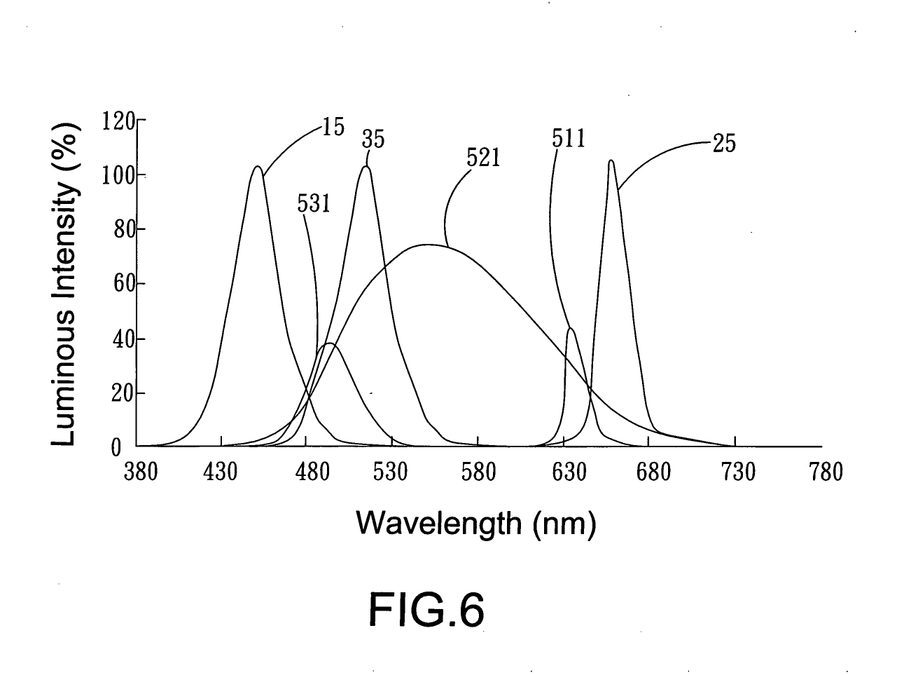

Referring to FIG. 5, another red illumination material 51 made by MgF₂, MgO, and GeO₂:Mn can be added to the illuminator 50, to be mixed with the aforementioned greenish yellow illumination material 52 and blue illumination material 53, such that when the illuminator 50 is excited by the blue light 15, a red light 511 will be excited and mixed with the blue light 531 and the greenish yellow light 521, to form a first mixed light 80′. Therefore, the first mixed light 80′ is provided with the red light 511, the blue light 531, and the greenish yellow light 521 of different wavelengths, wherein the wavelength of red light 511 lies in between 585 nm and 700 nm. Referring to FIG. 6, it shows the ranges of wavelengths and relative luminous intensities of independent blue light 15, red light 25, greenish yellow light 35, excited blue light 531, excited greenish yellow light 521, and excited red light 511, before mixing. It can be concluded that all of these six different lights have a specific wavelength and luminous intensity.

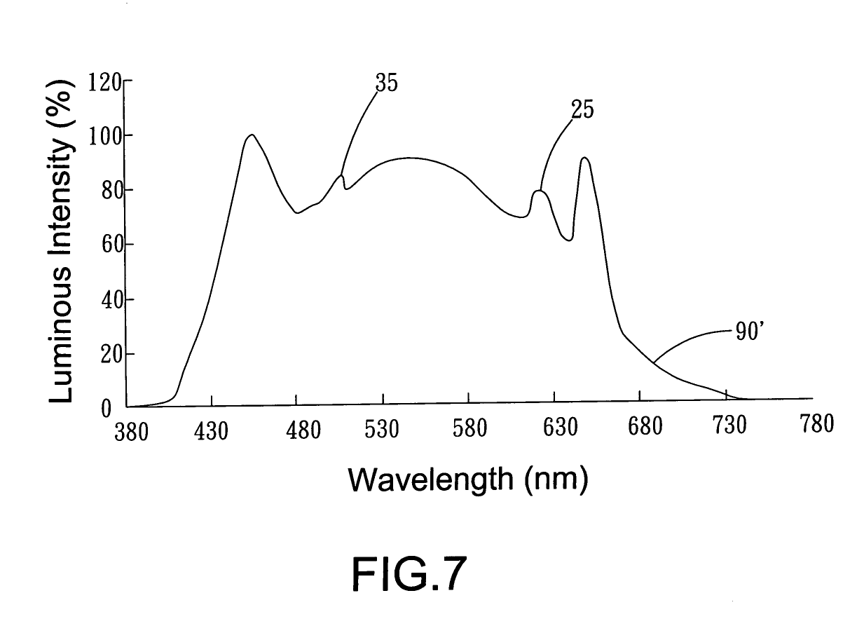

Referring to FIG. 9, the illumination layer 50 is directly sealed on a top of greenish yellow light LED 30, red light LED 20, and blue light LED 10. In the present invention, a special greenish yellow light LED 30 with a specified wavelength between 500 nm and 580 nm is added in the light reflection cap 60, to serve as another source of greenish yellow light 35. As shown in FIG. 8 and FIG. 9, a second mixed light 90′, whose wavelength is shown in FIG. 7, can be formed by mixing the greenish yellow light 35, the red light 25, and the blue light 15 with the aforementioned first mixed light 80′. By comparing the wave forms of the second mixed lights 90′, 90 in FIG. 7 and FIG. 4, it is concluded that a portion of the waveform intensity of red light 25 and the waveform intensity of greenish yellow light 35 are added to the second mixed light 90′ in FIG. 7. Therefore, by comparing the second mixed light 90′ in FIG. 7 with the daylight spectrum 95 (or natural light), it is concluded that the second mixed light 90′ is very similar to the daylight spectrum 95 in the visible light region of a wavelength between 400 nm and 680 nm. Accordingly, the second mixed light 90′ has the color (such as a white light) rendering effect closer to the natural light, and is provided with an enhanced saturation of color.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A white light emitting device comprising at least more than one blue light LED which can emit a blue light, at least more than one red light LED which can emit a red light, and an illuminator which is made by uniformly mixing a greenish yellow illumination material, a blue illumination material, and a transparent glue, wherein the greenish yellow illumination material is made by an Aluminate material using cerium (Ce) as its activator, and the blue illumination material is made by an Aluminate material using europium (Eu) as its activator; the illuminator being covered on an upper surface of blue light LED to absorb the blue light, such that the illuminator can be excited to a first mixed light having a wavelength different than that of the blue light; the first mixed light being mixed with a red light emitted from the red light LED to release a second mixed light; a greenish yellow light being emitted from the greenish yellow illumination material in the illuminator which is excited by the blue light having a wavelength between 500 nm and 585 nm; the blue light being emitted from the blue illumination material which is excited by the blue light having a wavelength between 450 nm and 500 nm; the first mixed light being formed by mixing these two lights of different colors.

2. The white light emitting device according to claim 1, wherein a red illumination material can be added to the illuminator to be mixed with the original greenish yellow illumination material and the blue illumination material; a red light emitted from the red illumination material which is excited by the blue light having a wavelength between 585 nm and 700 nm.

3. The white light emitting device according to claim 1, wherein the blue light LED and the red light LED are installed in a slot of a light reflection cap, the illumination layer formed by mixing the greenish yellow illumination material with the blue illumination material is covered on the blue light LED, and a transparent glue is filled in the slot to cover the illumination layer and the red light LED.

4. A white light emitting device comprising at least more than one blue light LED which can emit a blue light, at least more than one red light LED which can emit a red light, at least more than one greenish yellow light LED which can emit a greenish yellow light, and an illuminator made by uniformly mixing a greenish yellow illumination material, a blue illumination material and a transparent glue, wherein the greenish yellow illumination material is made by an Aluminate material using cerium (Ce) as its activator, and the blue illumination material is made by an Aluminate material using europium (Eu) as its activator; the illuminator being covered on an upper surface of the blue light LED to absorb the blue light, such that the illuminator can be excited to a first mixed light having a wavelength different than that of the blue light; the first mixed light being mixed with the red light and the greenish yellow light to release a second mixed light; a greenish yellow light being emitted from the greenish yellow illumination material in the illuminator which is excited by the blue light having a wavelength between 500 nm and 585 nm; the blue light being emitted from the blue illumination material which is excited by the blue light having a wavelength between 450 nm and 500 nm; the first mixed light being formed by mixing these two lights of different colors.

5. The white light emitting device according to claim 4, wherein the blue light LED, the red light LED, and the greenish yellow light LED are installed in a slot of a light reflection cap, and the illumination layer formed by mixing the greenish yellow illumination material with the blue illumination material is filled in the slot.

6. The white light emitting device according to claim 1 or 4, wherein the blue light emitted from the blue light LED has a wavelength between 400 nm and 480 nm, the red light emitted from the red light LED has a wavelength between 585 nm and 780 nm, and the greenish yellow light emitted from the greenish yellow light LED has a wavelength between 500 nm and 585 nm.

7. The white light emitting device according to claim 1 or 4, wherein the greenish yellow, blue, and red illumination materials in the illuminator can be chosen from one of or a combination of the following materials: (1) the Aluminate series, (2) the Siliccate series, (3) the Phosphate series, (4) the Bornate series, and (5) the Sulfide series.
